(19) United States
(12) Patent Application Publication
(10) Pub. No.: US 2024/0154768 A1
(43) Pub. Date: May 9, 2024

(54) DEVICES, SYSTEMS, AND METHODS FOR HANDLING NETWORK DEVICE COUNTERS

(71) Applicant: MELLANOX TECHNOLOGIES, LTD., Yokneam (IL)

(72) Inventors: Parav Kanaiyalal Pandit, Atlanta, GA (US); Adit Uday Ranadive, Mountain View, CA (US)

(21) Appl. No.: 17/980,677

(22) Filed: Nov. 4, 2022

(51) Int. Cl. H04L 5/00; H04L 12/12

(52) U.S. Cl. CPC H04L 5/0055; H04L 12/12

(57) ABSTRACT

Disclosed systems and methods include one or more receiving circuits receiving a request to define a network device and one or more response circuits, in response to the request, resetting one or more of a counter and a statistic associated with the network device and, after resetting the one or more of the counter and the statistic, assigning the network device to a container.

### FIELD OF THE DISCLOSURE

The present disclosure is generally directed to systems, devices, and methods for handling counters associated with network devices in relation to containers and virtual machines.

### BACKGROUND

Single root input/output (“I/O”) virtualization (“SR-IOV”) is a specification allowing for the isolation of Peripheral Component Interconnect (“PCI”) Express (“PCIe”) resources for manageability and performance reasons. The introduction of the SR-IOV and Sharing specification was a notable advancement toward hardware-assisted high performance I/O virtualization and sharing for PCIe devices. Since then, the landscape has evolved beyond deploying virtual machines (“VMs”) for computer server consolidation to hyper-scale data centers, which need to seamlessly add resources and dynamically provision containers. The new computing environment demands increased scalability and flexibility for I/O virtualization.

### BRIEF DESCRIPTION OF THE DRAWINGS

The present disclosure is described in conjunction with the appended figures, which are not necessarily drawn to scale:

FIG. 1 is an illustration of a computing environment in accordance with one or more of the embodiments described herein;

FIG. 2A is a flowchart of a method in accordance with one or more of the embodiments described herein;

FIG. 2B is a flowchart of a method in accordance with one or more of the embodiments described herein; and

FIG. 3 is an illustration of a graphical user interface in accordance with one or more of the embodiments described herein.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

SR-My provides different netdevices, such as virtual functions (“VFs”), to different virtual components, such as containers, on a physical device, such as a server. SR-IOV allows different containers and/or VMs in virtual environments to share a single PCIe hardware interface. As described herein, when a container or VM is deployed in a computing environment, the container or VM may be assigned one or more netdevices in the form of PFs, VFs, SFs, or other devices.

Contemporary methods of deploying containers with assigned network devices (“netdevices”), such as virtual functions (“VFs”), physical functions (“PFs”), scalable functions (“SFs”), etc., are inadequate due to statistical inaccuracy and time delays.

Namespaces are a feature of the Linux kernel which can be used to partition kernel resources such that one set of processes sees one set of resources while another set of processes sees a different set of resources. In this way, namespaces can be utilized to isolate processes from each other. As described herein, netdevices can be assigned to containers and/or VMs. It should also be appreciated that netdevices may be resources than can be assigned to processes running on the OS. If two containers are started on a single server, each container can be isolated for network access by means of network namespace. For example, if a developer starts two containers on a single server, each container can be isolated from the other.

SR-IOV, or SIOV, uses netdevices such as PFs, SFs, and VFs to control or configure PCIe devices. PFs have the ability to move data in and out of a device such as a server while VFs are lightweight PCIe functions supporting data flow. VFs, SFs, and PFs available to a hypervisor or a guest operating system may depend on the particular PCIe device being used.

When a container is deployed in an SR-IOV or SIOV environment, the container is assigned one or more netdevices, such as VFs, PFs, SFs, or virtio NICs. Each netdevice is associated with a set of statistics, which may be stored in memory and/or in the device itself in one or more counters or registers. When a netdevice, which was previously assigned to a past container, is assigned to a new container, the statistics associated with the past container must be dealt with or else will carry on with the netdevice after the netdevice is assigned to the new container. If not properly handled, the statistics for the netdevice which are associated with the past container may cause telemetry and data processing issues as numbers associated with transmitted and/or received packets for each netdevice associated with the past container can be mistakenly associated with the new container which should be expected to have zero transmitted and received packets. What is needed is a system capable of assigning netdevices to containers in such a way as to avoid creating the telemetry and data processing issues. One method which has been used to handle statistics associated with a previous container is to destroy the netdevice and recreate the netdevice for a new container. Additionally, when destroying and recreating a netdevice is not possible, user disable and enable the virtual function or subfunction or scalable function or reinitialize the virtio network device. Such a method results in slower container deployment time for function-as-a-service (FAAS) and other container use cases. The systems and methods describes herein provide increased scalability and flexibility for I/O virtualization and rapid provisioning of I/O devices without incurring such delays in container deployment time.

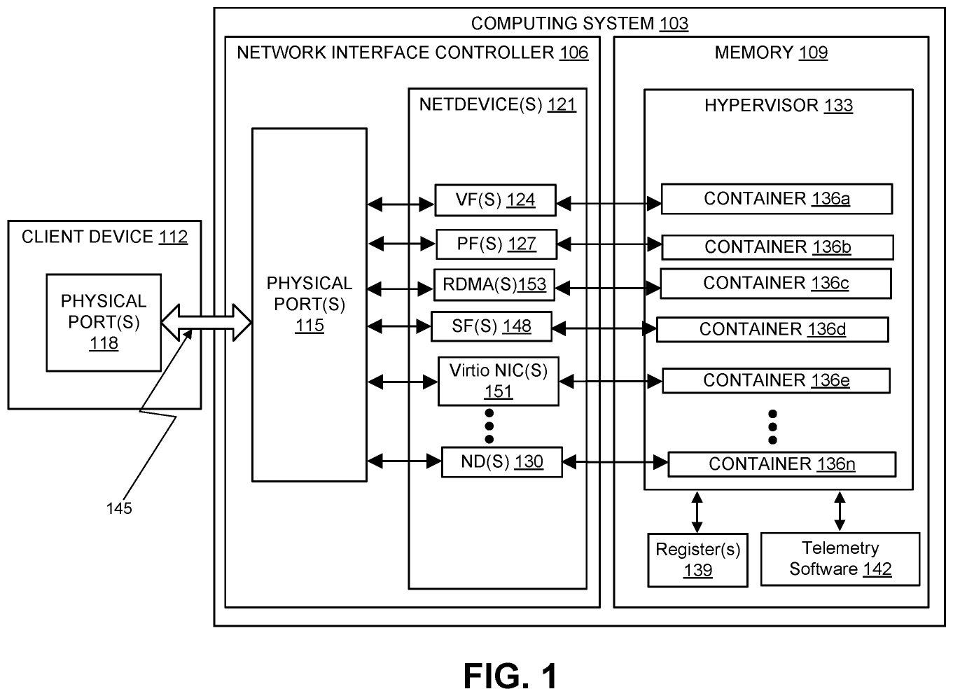

As illustrated in FIG. 1, a computing system 103, such as a server, may comprise a network interface controller (NIC) 106 and a memory storage device 109. The system 103 may be in communication with a client device 112. One or more physical ports 115 of the NIC 106 may be used to communicate directly with via one or more physical ports 118 of the client device 112. The NIC 106 may comprise one or more Central Processing Units (CPUs). The memory 109 may comprise one or more of volatile and/or non-volatile storage devices. Non-limiting examples of suitable memory devices for the memory include flash memory, Random Access Memory (RAM), variants thereof, combinations thereof, or the like. The memory may be main system memory of the computing system 103, peripheral device dedicated memory (e.g., Graphics Processing Unit (GPU) memory), encrypted storage (e.g., NVMe Over Fabric), and/or storage class memory.

The computing system 103 of FIG. 1 is one example of a system 103 configuration in which containers 136a-n and/or VMs may be deployed. A link 145 or communication channel may connect the computing system 103 with one or more client devices 112. Examples of devices which may be used in association with the computing system 103 include, without limitation, edge routers, switches, Network Interface Cards, Top of Rack (ToR) switches, server blades, etc.

Each physical port 115 of the NIC 106 may be associated with a netdevice 121. Netdevices 121 may comprise, for example, one or more of a PF 127, VF 124, SF 148, virtio NIC 151, RDMA devices 153, or other netdevice 130.

A PF may be a physical I/O resource or a PCIe function supporting SR-IOV capabilities. Each PF may be shared by a plurality of VMs. Each shared PF may provide dedicated resources and may use shared common resources. Using PFs, each VM may have access to unique resources.

A VF may be described as a PCIe function associated with a PF. A VF may share one or more physical resources with a PF as well as with other VFs associated with the same PF. Each VF has dedicated queues for transmitting (Tx) and receiving (Rx). Each VF has lightweight PCIe resources (registers, counters, base address registers (BARs), etc.) such that each VF can Rx and Tx data.

An SF is a lightweight function that has a parent PCI function on which it is deployed. An SF may have one or more of its own dedicated queues and/or shared queues. For example, it may be possible for multiple SFs to share one or more queues. These queues are neither shared nor stolen from the parent PCI function. SFs are deployed in units of one unlike SR-IOV VFs which may be enabled all together. When a new container is spawned, a needed SF can be created and deployed. SFs do not have to implement full PCI config space, reset, registers. This makes the device light weight.

While the disclosure generally describes the use of netdevices, it should be appreciated the same or similar systems and methods described herein may be applied to the use of remote direct memory access (“RDMA”) devices as well. RDMA provides direct memory access by one host device to the memory of another host device without involving a remote OS or CPU.

Each netdevice 130 may be used to provide resources to a container 136a-n. Resources as described herein can be utilized in a virtualized environment. In a virtualized environment, a hypervisor 133 executing within the system 103 provides an abstraction layer enabling various resources of the system 103 to be shared as multiple virtual computing systems (referred to as containers and/or virtual machines (“VMs”)). A hypervisor 133 may be referred to as a container manager or virtual machine manager (“VMM”). Each of the containers and/or VMs may run its own operating system (“OS”) and behave as though it is an independent and separate computing system, even though all of the containers and/or VMs may actually be running on a single physical computing system.

Instead of virtualizing the underlying hardware, containers virtualize the operating system (typically Linux) so that each container contains only the application and its libraries and dependencies. In some embodiments, containers may correspond to the description of VMs, which means containers on a single OS can attain the processing isolation afforded to VMs described herein.

In the example illustrated in FIG. 1, the hypervisor 133 hosts a plurality of containers 136a-n. A host OS hosts each container, and each container is assigned one or more hardware resources (VFs, PFs, etc.) by a hypervisor. The kernel may then load a driver for each container.

Virtualizing resources has many advantages. In particular, a virtualized environment enables efficiency improvements and better utilization of resources within the environment relative to a traditional processing environment. As a result, a virtualized environment typically needs fewer hardware and software resources to provide the same processing functionality relative to a traditional processing environment. This, in turn, results in reduced costs for acquiring, operating, and maintaining those hardware and software resources relative to a traditional processing environment. Using containers as described herein provides a number of benefits as compared to VMs, for example:

Lightweight: Containers share a machine OS kernel, eliminating the need for a full OS instance per application and making container files small and easy on resources. Their smaller size, especially compared to virtual machines, means they can spin up quickly and better support applications that scale horizontally.

Portable and platform independent: Containers carry all their dependencies with them, meaning that software can be written once and then run without needing to be re-configured across laptops, cloud, and on-premises computing environments.

Supports modern development and architecture: Due to a combination of their deployment portability/consistency across platforms and their small size, containers are an ideal fit for modern development and application patterns—such as DevOps, serverless, and microservices—that are built are regular code deployments in small increments.

Improves utilization: Like VMs, containers enable developers and operators to improve CPU and memory utilization of physical machines. Where containers go even further is that because they also enable microservice architectures, application components can be deployed and scaled more granularly, an attractive alternative to having to scale up an entire monolithic application because a single component is struggling with load.

Containers may be used for short-term applications, such as serverless computing, microservices, etc. Such services may last only for a few seconds or minutes. For this reason, the speed and low latency of container provisioning is particularly important.

Cost savings: in one infrastructure many systems, such as VMs and containers, can be run simultaneously.

Agility and speed: instead of provisioning an entire new environment, you can just use a VM.

Lower downtime: if a host goes out unexpectedly, you can quickly move VMs to another HV on another host.

To fully achieve the advantages provided by containers and virtualization, container provisioning latency needs to be short. When a new container is needed for a client device 112 or for another use, the container needs to be initialized for the client device 112 in as short a time as possible to avoid downtime.

Initializing a container involves assigning one or more netdevices 124, 127, 130 to the container. Each netdevice 124, 127, 130 may be associated with one or more statistics which may be stored in registers 139, or counters, or another form of memory. Statistics may include numbers such as RX packets, RX errors, RX dropped packets, RX overruns, RX frame, TX packets, TX errors, TX dropped packets, TX overruns, TX carrier, TX collisions, TXqueuelen, Total size of RX (bytes), total size of TX (bytes), etc.

For example, a netdevice may be associated with an rx_packets statistic representing a number of good packets received by the interface. For hardware interfaces, rx_packets may count all good packets received from the device by the host, including packets which host had to drop at various stages of processing (even in the driver).

In some embodiments, a netdevice may be associated with a tx_packets statistic representing a number of packets successfully transmitted by the netdevice. For hardware interfaces, tx_packets may count packets which a host was able to successfully hand over to the device, which may not necessarily mean that packets had been successfully transmitted out of the device, only that device acknowledged it copied them out of host memory.

In some embodiments, a netdevice may be associated with an rx_bytes statistic representing a number of good received bytes. For IEEE 802.3, rx_bytes should include a count of the length of Ethernet frames excluding FCS.

In some embodiments, a netdevice may be associated with a tx_bytes statistic representing a number of good transmitted bytes. For IEEE 802.3, tx_bytes should a count of the length of Ethernet frames excluding the FCS.

In some embodiments, a netdevice may be associated with an rx_errors statistic representing a total number of bad packets received by the netdevice. Rx_errors may include events counted by rx_length_errors, rx_crc_errors, rx_frame_errors, and other errors not otherwise counted.

In some embodiments, a netdevice may be associated with a tx_errors statistic representing a total number of transmit problems. Tx_errors may include events counter by tx_aborted_errors, tx_carrier_errors, tx_fifo_errors, tx_heartbeat_errors, tx_window_errors, and other errors not otherwise counted.

In some embodiments, a netdevice may be associated with an rx_dropped statistic representing a number of packets received but not processed, e.g., due to lack of resources or unsupported protocol. For hardware interfaces, rx_dropped may include packets discarded due to L2 address filtering and may or may not include packets dropped by the device due to buffer exhaustion which are counted separately in rx_missed_errors.

In some embodiments, a netdevice may be associated with a tx_dropped statistic representing a number of packets dropped on their way to transmission, e.g., due to lack of resources.

In some embodiments, a netdevice may be associated with a multicast statistic representing a number of multicast packets received. For hardware interfaces multicast may be calculated at the device level (unlike rx_packets) and therefore may include packets which did not reach the host. For IEEE 802.3 devices, multicast may be equivalent to 30.3.1.1.21 aMulticastFramesReceivedOK.

In some embodiments, a netdevice may be associated with a collisions statistic representing a number of collisions during packet transmissions.

In some embodiments, a netdevice may be associated with an rx_length_errors statistic representing a number of packets dropped due to invalid length. For IEEE 802.3 devices rx_length_errors may be equivalent to a sum of the following attributes: 30.3.1.1.23 aInRangeLengthErrors; 30.3.1.1.24 aOutOfRangeLengthField; and/or 30.3.1.1.25 aFrameTooLongErrors.

In some embodiments, a netdevice may be associated with an rx_over_errors statistic representing a receiver FIFO overflow event counter. Rx_over_errors may represent a count of overflow events. Such events may be reported in the receive descriptors or via interrupts and may or may not correspond one-to-one with dropped packets.

In some embodiments, a netdevice may be associated with an rx_crc_errors statistic representing a number of packets received with a CRC error. Part of aggregate “frame” errors in/proc/net/dev. For IEEE 802.3 devices this counter may be equivalent to 30.3.1.1.6 aFrameCheckSequenceErrors.

In some embodiments, a netdevice may be associated with an rx_frame_errors statistic representing a number of receiver frame alignment errors. For IEEE 802.3 devices this statistic may be equivalent to: 30.3.1.1.7 aAlignmentErrors.

In some embodiments, a netdevice may be associated with an rx_fifo_errors statistic representing a number of FIFO errors and/or overflow events associated with a receiver.

In some embodiments, a netdevice may be associated with an rx_missed_errors statistic representing a count of packets missed by the host. Rx_missed_errors may be used to count a number of packets dropped by the device due to lack of buffer space.

In some embodiments, a netdevice may be associated with a tx_aborted_errors statistic representing a number of carrier errors in/proc/net/dev. For IEEE 802.3 devices capable of half-duplex operation, tx_aborted_errors may be equivalent to 30.3.1.1.11 aFramesAbortedDueToXSColls.

In some embodiments, a netdevice may be associated with a tx_carrier_errors statistic representing a number of frame transmission errors due to loss of carrier during transmission. For IEEE 802.3 devices, this statistic may be equivalent to 30.3.1.1.13 aCarrierSenseErrors.

In some embodiments, a netdevice may be associated with a tx_fifo_errors statistic representing a number of frame transmission errors due to device FIFO underrun and/or underflow.

In some embodiments, a netdevice may be associated with a tx_heartbeat_errors statistic representing a number of Heartbeat and/or SQE test errors for half-duplex Ethernet. For IEEE 802.3 devices, tx_heartbeat_errors may be equivalent to 30.3.2.1.4 aSQETestErrors.

In some embodiments, a netdevice may be associated with a tx_window_errors statistic representing a number of frame transmission errors due to late collisions (for Ethernet—after the first 64B of transmission). For IEEE 802.3 devices this statistic may be equivalent to 30.3.1.1.10 aLateCollisions.

In some embodiments, a netdevice may be associated with an rx_compressed statistic representing a number of correctly received compressed packets.

In some embodiments, a netdevice may be associated with a tx_compressed statistic representing a number of transmitted compressed packets.

In some embodiments, a netdevice may be associated with an rx_nohandler statistic representing a number of packets received on the interface but dropped by the networking stack because the device is not designated to receive packets (e.g., backup link in a bond).

In some embodiments, a netdevice may be associated with an rx_otherhost dropped statistic representing a number of packets dropped due to mismatch in destination MAC address.

The above statistics are just examples of many statistics that can be utilized in connection with a system 103. In some embodiments, hundreds of statistics may be tracked in relation to netdevices and systems incorporating the same.

The statistics described herein may be stored in registers 139 and may be used by systems such as telemetry software 142 or for other purposes.

When a container is initialized, the container expects to start with zeroed statistics in the counters for each netdevice. For example, if a container starts with a counter indicating one million packets have been sent and received, telemetry software may be in a confused state. However, when an existing netdevice 121 is assigned to a new container, the existing netdevice 121 may be associated with statistics stored in registers 139 as described above.

Because such statistics cause confusion with telemetry software 142, what is needed is a way to resolve the confusion. As described herein, freshly created netdevices 121 may be supplied to a new container when the container is deployed.

When a container is started, provisioned, or initialized with a NIC, any counters or statistics associated with the NIC should be expected to be at zero to avoid confusion. If not, telemetry software can be confused. For example, if a container starts and counters associated with an NIC indicate 1M packets sent and received, the telemetry software can be confused. Confusion in telemetry can set off false alarms—numbers of errors occurred, amount of traffic sent, etc. A spike from zero packets to a high number of packets sent in less than a second can trigger an alarm. Telemetry accuracy is also important as clients may be billed based on an amount of traffic, inaccuracies can cause billing errors. To resolve this, some systems freshly create new devices (VFs, SF s) to supply to the container. When a container is no longer needed, any devices may be destroyed.

One way to supply netdevices 121 with empty statistics to a new container is to, upon a new container being initialized, destroy and recreate any netdevices needed by the container. It has been seen that recycling 32 VFs requires 51 seconds before the VFs can be used by a new container. This problem is exacerbated when containers are deployed in scale. For example, a single server may be required to deploy hundreds of containers simultaneously or within a short amount of time.

The more time it takes to provision a new container, the greater the risk of the CPU cycle to not make their CPU available for actual computing uses. Every time destroying and recreating device slows down spawning time of the container. While this way provides accurate statistics, it creates excessive delays. Any needed netdevice must first be destroyed after a container is terminated and next must be recreated before starting the new container.

Also, software is required to maintain a cache of recycling netdevices, such as VFs. And even with a cache of recycling netdevices, firmware and system functions will be occupied in the work of destroying and recreating work. In such systems, the software maintains a cache of devices in use. Before each device is reused, the device is destroyed and recreated.

An option to avoid the delay and system requirements associated with recycling netdevices is to simply reuse the netdevices. This option creates the inaccurate statistics issue described above, in which statistics associated with an older container leak to new containers, causing confusion in telemetry software which shows high statistics for TX and RX for a newly deployed container. Furthermore, leaking counters and statistics of one container to another container may cause the leak of side band data of a container. Such a leak may be considered a security leak. For this reason, avoiding the leak of counters and statistics between containers may be beneficial for security reasons as well.

Conventionally, to assign the needed netdevices to the container, existing netdevices are either (1) assigned to the container (causing statistics problems), (2) destroyed and recreated, or (3) reinitialized. Assigning existing netdevices to the container causes an issue in that statistics associated with each netdevice, such as transmitting (“tx”) and receiving (“rx”) counters, contain data making it appear the newly deployed container has sent and/or received data. This causes issues with telemetry systems. Destroying and recreating netdevices and/or reinitializing netdevices causes problems in that the time it takes to destroy and recreate or reinitialize a netdevice causes a delay in the deployment of the new container.

As described herein, a process of refurbishing a netdevice provides a way to quickly assign netdevices to new containers without incurring excessive delays and telemetry confusion.

What is needed is a way to provide netdevices to a container without causing a delay and without causing confusion to telemetry systems.

While illustrated and described as a computing system, it should be appreciated that the computing system 103 may correspond to any type of device that becomes part of or is connected with a communication network. Other examples of suitable devices that may act or operate like the computing system 103 as described herein include, without limitation, one or more of a Personal Computer (PC), a laptop, a tablet, a smartphone, a server, a collection of servers, or the like.

The communication channel connecting the client device 112 and the computing system 103 may in some embodiments be any type of communication network (whether trusted or untrusted). Examples of a communication network that may be used to connect computing system 103 with a client device 112 include, without limitation, an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network enables data transmission between the computing system 103 and client device 112 using optical signals. In this case, the computing system 103 and the communication network may include waveguides (e.g., optical fibers) that carry the optical signals. In one specific, but non-limiting example, the communication network enables data transmission between the computing system 103 and the client device 112 using electrical signals. In this case, the communication network may include conductive wires (e.g., copper wires) that carry the electrical signals. In one embodiment, the communication network enables data transmission with both electrical and optical signals.

The computing system 103 may further include processing circuitry to control various functions of the computing system 103. The processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally, or alternatively, the processing circuitry may comprise hardware, such as an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry.

Although not explicitly shown, it should be appreciated that the computing system 103 may include other storage devices and/or processing circuitry for carrying out computing tasks, for example, tasks associated with controlling the flow of data over the communication network. It should be further understood that such processing circuitry may take the form of hardware and/or software in the same or similar manner as the processing circuitry.

In addition, although not explicitly shown, it should be appreciated that the computing system 103 may include one or more communication interfaces for facilitating wired and/or wireless communication between the computing system 103 and the client device 112 and other unillustrated elements.

As can be appreciated, various design considerations will be described in connection with different computing systems 103. It should be appreciated that any combination of approaches can be combined or portions of certain approaches may be used without departing from the scope of the present disclosure.

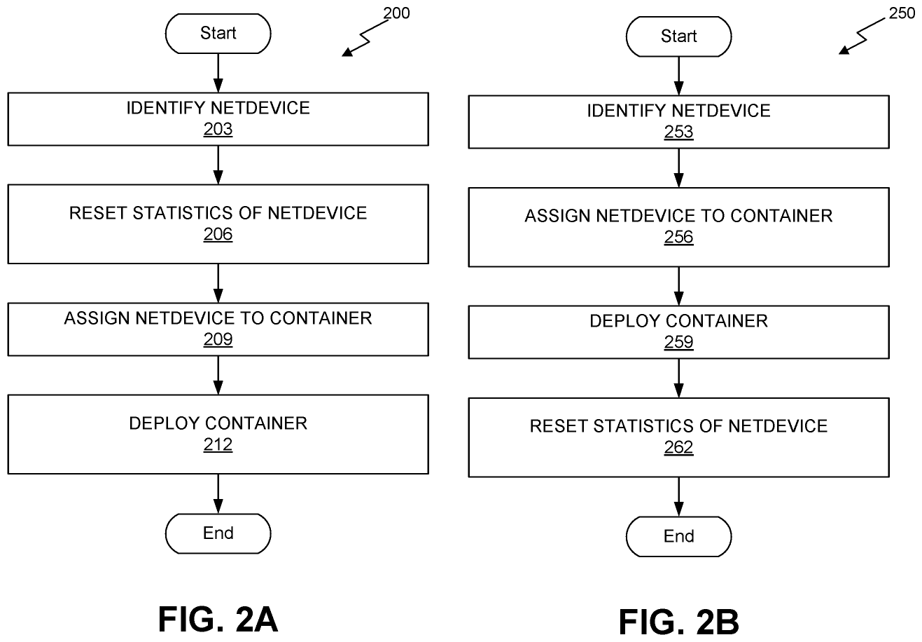

FIGS. 2A and 2B illustrate methods 200 and 250, respectively, each according to at least one example embodiment. The methods 200, 250 (and/or one or more stages thereof) may be carried out or otherwise performed by various elements of the computing system 103, for example, by the network interface controller 106 and/or the hypervisor 133. For the sake of explanation, FIGS. 2A and 2B will be described with reference to FIG. 1.

As illustrated in FIG. 2A, a method 200 of providing netdevices to containers in such a way as to resolve the delay and inaccuracies inherent in conventional solutions as described above may be performed in accordance with one or more of the embodiments described herein.

The method 200 may begin with a processor of a computing system, such as a server or other host device, receiving instructions to create, deploy, initialize, or otherwise start a new container. The processor may be of a computing system 103 as illustrated in FIG. 1 and/or may comprise one or more receiving circuits capable of receiving requests. In some embodiments, instructions to create a new container may be in the form of a request received from another device. Instructions to create a new container may comprise a request to define a network device.

New containers may be needed, for example, when a client device seeks to launch a new microservice. Regardless of the circumstances, the method 200 illustrated in FIG. 2A may be executed in the event that a container is to be created. Furthermore, while the term container is used in the description of this method, it should be appreciated the same or similar methods may be performed in association with the creation of VMs as opposed to containers.

At 203, the processor may identify one or more netdevices which should be assigned to the container. In some embodiments, identifying netdevices to be assigned to the container may comprise comparing a request for the container with currently available netdevices. As described herein, a netdevice may be one or more of a PF, VF, SF, or other device.

At 206, the processor may reset statistics associated with each of the netdevices identified at 203. Resetting statistics may comprise identifying a set of one or more counters associated with each netdevice and writing a zero in the counter or adjusting a pointer to indicate a zero for the counter. Statistics may be associated with counters in multiple layers, such as in the user space, in the Linux kernel, in device drivers, and/or other firmware and/or software locations. The statistics may be reset by a processor of the computing system 103 as illustrated in FIG. 1 and/or may comprise one or more receiving circuits capable of resetting statistics and assigning netdevices to containers.

At 209, the processor may assign the one or more netdevices to the container. In one or more of the embodiments described herein, assigning netdevices to a container may comprise moving the netdevices into a namespace of the container.

At 212, the processor may deploy the container. Deploying the container may comprise, in at least one embodiment, enabling access to the container for one or more client devices or transmitting an indication to one or more client devices with information relating to the container.

The method 200 may end with a container having assigned netdevices with zero statistics at the time of deployment.

In some embodiments, statistics associated with a netdevice can be reset after the netdevice has been provided to the container. In some embodiments, a command to reset the statistics may come from a hypervisor, a docker system, or the container for which the netdevice is needed.

A request or command may originate in a user space and may be received by a Linux kernel. The Linux kernel may, based on the request, issue a command to the actual device driver instructing the driver to reset any counters associated with statistics in firmware and/or software. The request or command from the user space may be created using, for example, iproute2/ip.

For example, as illustrated in FIG. 2B, a method 250 may comprise providing netdevices to containers prior to resetting the statistics associated with each of the netdevices.

The method 250 may begin with a processor of a computing system, such as a server or other host device, receiving instructions to create, deploy, initialize, or otherwise start a new container. In some embodiments, instructions to create a new container may be in the form of a request received from another device.

At 253, the processor may identify one or more netdevices which should be assigned to the container. In some embodiments, identifying netdevices to be assigned to the container may comprise comparing a request for the container with currently available netdevices. As described herein, a netdevice may be one or more of a PF, VF, SF, or other device.

At 256, the processor may assign the one or more netdevices to the container. In one or more of the embodiments described herein, assigning netdevices to a container may comprise moving the netdevices into a namespace of the container.

At 259, the processor may deploy the container. Deploying the container may comprise, in at least one embodiment, enabling access to the container for one or more client devices or transmitting an indication to one or more client devices with information relating to the container.

At 262, the processor may reset statistics associated with each of the netdevices identified at 203. Resetting statistics may comprise identifying a set of one or more counters associated with each netdevice and writing a zero in the counter or adjusting a pointer to indicate a zero for the counter. Statistics may be associated with counters in multiple layers, such as in the user space, in the Linux kernel, in device drivers, and/or other firmware and/or software locations.

The method 250 may end with a container having assigned netdevices with zero statistics.

The above methods may also, in some embodiments, be used outside of the creation of a new container, such as in the instance that a user seeks not to launch a new container, but instead to reuse a netdevice for another purpose.

In one or more of the embodiments described herein, statistics associated with a netdevice can be reset automatically upon the netdevice exiting the kernel namespace using the same or a similar method as described above in relation to FIGS. 2A and 2B.

The above method of FIG. 2A, enabling the resetting of statistics after deployment of a container may prove useful in the event of an error occurring in relation to a container. In the event of an error, the counters may be reset, and the counters may be monitored for a particular amount of time (e.g., 10 min). In such a case, the container may continue running, but the counters can be reset and used for debugging.

In some embodiments, an automated method of resetting statistics may be executed automatically in response to an error event being detected. For example, one or more error scenarios may be set as triggers for the resetting of statistics for a container. In response to the error scenario, the statistics may be reset and monitored for a predetermined amount of time.

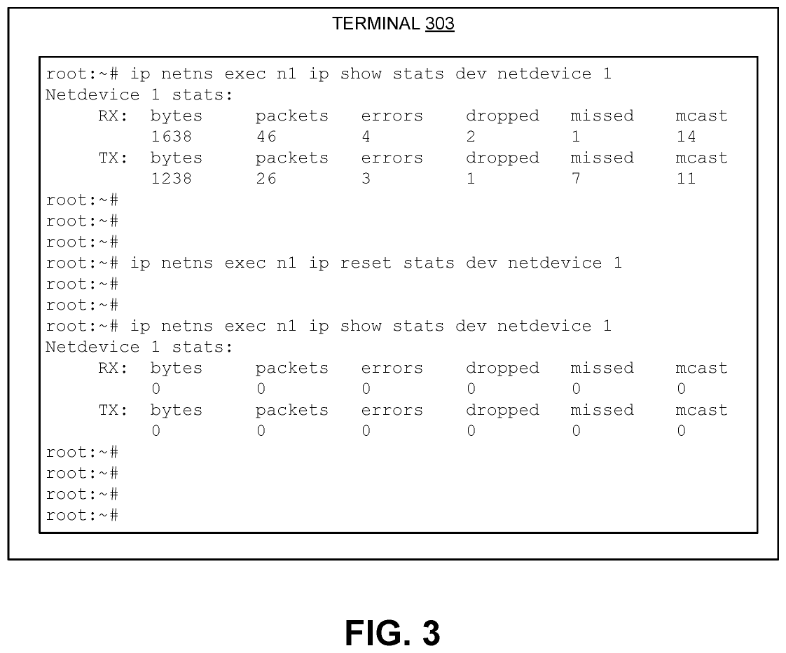

As illustrated in FIG. 3, a user interface may be accessed by a user via a terminal 303 in the Linux kernel. The user may be enabled to input commands to view current statistics of a netdevice and to manually reset the statistics of the netdevice.

The commands “show stats of netdevice 1” and “reset stats of netdevice 1” are shown for illustration purposes only.

As should be appreciated based on the illustration of FIG. 3, in response to a show stats of netdevice 1 command, a list of statistics associated with a first netdevice may be displayed. In response to a reset stats of netdevicel command, the statistics associated with the first netdevice may be reset to zero. By reentering the show stats of netdevice 1 command, the zeroed statistics may be seen.

The statistics of RX and TX bytes, RX and TX packets, RX and TX errors, RX and TX dropped, RX and TX missed, and RX and TX miscast are also shown for illustration purposes only. A greater or lesser number of statistics may be shown in some embodiments as described above.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Example embodiments may be configured as follows:
(1) A device, comprising:
one or more receiving circuits to receive a request to define a network device; and
one or more response circuits to, in response to the request:
   reset one or more of a counter and a statistic associated with the network device; and
   after resetting the one or more of the counter and the statistic, assign the network device to a container.
(2) The device of (1), wherein the network device is associated with a physical function.
(3) The device of one or more of (1) to (2), wherein the network device is associated with a virtual function.
(4) The device of one or more of (1) to (3), wherein the network device is associated with a scalable function or an SIOV device.
(5) The device of one or more of (1) to (4), wherein the method is performed by a network interface controller.
(6) The device of one or more of (1) to (5), wherein the method is performed by a hypervisor.
(7) The device of one or more of (1) to (6), wherein the one or more of the counter and the statistic comprises one or more queues.
(8) The device of one or more of (1) to (7), wherein the one or more of a counter and a statistic comprises a number of bits transmitted and received by the network device prior to being assigned to the container.
(9) The device of one or more of (1) to (8), wherein the one or more of the counter and the statistic comprises a number of packets transmitted and received by the network device prior to being assigned to the container.
(10) The device of one or more of (1) to (9), wherein the one or more of the counter and the statistic comprises a number of errors associated with the network device prior to being assigned to the container.
(11) The device of one or more of (1) to (10), wherein resetting the one or more of the counter and the statistic comprises setting values associated with each of the one or more of the counter and the statistic to zero.
(12) The device of one or more of (1) to (11), wherein the one or more of the counter and the statistic is stored in a registry associated with the network device.
(13) A system, comprising:
a network interface controller (NIC) storing, in memory, one or more statistics associated with one or more containers, wherein in response to receiving a request to define a network device, the NIC:
   resets one or more of a counter and a statistic associated with the network device; and
   after resetting the one or more of the counter and the statistic, assigns the network device to a container.
(14) The system of (13), wherein the network device is associated with a physical function.
(15) The system of one or more of (13) to (14), wherein the network device is associated with a virtual function.
(16) The system of one or more of (13) to (15), wherein the network device is associated with a scalable function.
(17) A method of assigning network devices to containers, the method comprising:
receiving a request to define a network device; and
in response to the request:
   resetting one or more of a counter and a statistic associated with the network device; and
   after resetting the one or more of the counter and the statistic, assigns the network device to a container.
(18) The method of (17), wherein the network device is associated with a physical function.
(19) The method of one or more of (17) to (18), wherein the network device is associated with a virtual function.
(20) The method of one or more of (17) to (19), wherein the network device is associated with a subfunction.

What is claimed is:

1. A device, comprising:
one or more receiving circuits to receive a request to define a network device; and
one or more response circuits to, in response to the request:
reset one or more of a counter and a statistic associated with the network device; and
after resetting the one or more of the counter and the statistic, assign the network device to a container.

2. The device of claim 1, wherein the network device is associated with a physical function.

3. The device of claim 1, wherein the network device is associated with a virtual function.

4. The device of claim 1, wherein the network device is associated with one or more of a scalable function, a subfunction, and an SIOV device.

5. The device of claim 1, wherein the method is performed by a network interface controller.

6. The device of claim 1, wherein the method is performed by a hypervisor.

7. The device of claim 1, wherein the one or more of the counter and the statistic comprises one or more queues.

8. The device of claim 1, wherein the one or more of a counter and a statistic comprises a number of bits transmitted and received by the network device prior to being assigned to the container.

9. The device of claim 1, wherein the one or more of the counter and the statistic comprises a number of packets transmitted and received by the network device prior to being assigned to the container.

10. The device of claim 1, wherein the one or more of the counter and the statistic comprises a number of errors associated with the network device prior to being assigned to the container.

11. The device of claim 1, wherein resetting the one or more of the counter and the statistic comprises setting values associated with each of the one or more of the counter and the statistic to zero.

12. The device of claim 1, wherein the one or more of the counter and the statistic is stored in a registry associated with the network device.

13. The device of claim 1, wherein the network device is associated with one or more of a virtio network device and an RDMA device.

14. A system, comprising:
a network interface controller (NIC) storing, in memory, one or more statistics associated with one or more containers, wherein in response to receiving a request to define a network device, the NIC:
resets one or more of a counter and a statistic associated with the network device; and
after resetting the one or more of the counter and the statistic, assigns the network device to a container.

15. The system of claim 14, wherein the network device is associated with a physical function.

16. The system of claim 14, wherein the network device is associated with a virtual function.

17. The system of claim 14, wherein the network device is associated with one or more of a scalable function, a subfunction, and an SIOV device.

18. A method of assigning network devices to containers, the method comprising:
receiving a request to define a network device; and
in response to the request:
resetting one or more of a counter and a statistic associated with the network device; and
after resetting the one or more of the counter and the statistic, assigning the network device to a container.

19. The method of claim 17, wherein the network device is associated with a physical function.

20. The method of claim 17, wherein the network device is associated with a virtual function.
